(19) United States
(12) Patent Application Publication
(10) Pub. No.: US 2026/0280319 A1
(43) Pub. Date: Sep. 17, 2026

(54) Energy Supply System Having Battery Modules, and Method for Operating an Energy Supply System

(71) Applicant: instagrid GmbH, Ludwigsburg (DE)

(72) Inventors: Sebastian Berning, Stuttgart (DE); Reza Hezariyan, Stuttgard (DE)

(21) Appl. No.: 19/676,085

(22) Filed: May 13, 2026

Related U.S. Application Data
(63) Continuation of application No. 18/289,678, filed on Apr. 26, 2022.

(30) Foreign Application Priority Data
May 6, 2021 (DE) 10202111186.2

(51) Int. Cl. H02J 7/60; H02J 7/50; H02J 7/90; H02J 7/96

(52) U.S. Cl. CPC H02J 7/663; H02J 7/50; H02J 7/96; H02J 7/977

(57) ABSTRACT

An energy supply system that includes battery modules which can be controllably connected in series to provide different voltages at a power supply connection. Each of the battery modules has an input connection and an output connection, a battery unit for providing a module voltage, a switching device for selectively switching the module voltage to the input connection and to the output connection, and a control input for receiving a control input signal. The battery modules are each configured so as to assume, in response to a switch-off control signal at the control input, a switched-off state in which the module voltage is disconnected from the input and output connections. In response to detecting an impermissible operating state of any battery module, a fault control circuit transmits the switch-off control signal to cause each battery module to assume the switched-off state.

### CROSS-REFERENCE TO RELATED APPLICATIONS

This application is a continuation of U.S. patent application Ser. No. 18/289,678, filed Apr. 26, 2022, which is the 35 U.S.C. § 371 National Stage Patent Application No. PCT/EP2022/061097, filed on Apr. 26, 2022, which claims the benefit of German Patent Application No. 10 2021 111 866.2, filed on May 6, 2021, the disclosures of which are incorporated herein by reference in their entirety.

### TECHNICAL FIELD

The disclosure relates to an energy supply system having several battery modules, and to a method for operating an energy supply system.

### BACKGROUND

Today, power generators with internal combustion engines are almost exclusively used for the mobile power supply unit of high-performance working machines, such as diamond drills, high-pressure cleaners or industrial vacuum cleaners, for instance. This applies particularly to machines with an electric input power above 1 kW. Due to the increasing burden on the environment and health, it is desirable to operate such devices with battery storage systems.

One feasible solution are portable battery storage systems directly providing a grid-compatible alternating voltage at an output, e.g. 230 V/50 Hz or 115 V/60 Hz. This output may be configured as a plugging device, for instance, with which commercially available grid consumers can be connected. Today, such battery storage systems are available on the market in a plurality of different versions. However, the available devices have disadvantages that considerably limit their use. Thus, their technical configuration moves within conflicting priorities between output power and weight. In the sense of current work safety conditions, battery storage systems with a high output power >2.5 kW are, as a rule, not capable of being carried by a single person with a weight >20 kg, or offer a storage capacity (<1 kWh) that is too low. Though battery storage systems with a lower output power are lighter, they cannot be used for the above-described applications.

Apart from the output power provided on average, the so-called overload capacity also plays a role. Commercially available battery storage systems typically provide 50% more current in the short term (a few seconds) than in permanent operation. However, large consumers, such as those with so-called capacitor motors (one-phase asynchronous machines) require up to ten times as much current for the start-up. While this is no problem on the power grid, there is no solution so far for the mobile operation with batteries.

U.S. Pat. No. 8,994,336 B2 describes a development in which the battery cells are arranged in a series in such a way that their voltage is above the peak voltage of the alternating voltage to be generated. Thus, both the overload capacity and the power density of the battery storage system are improved. However, an inverter of a common type is further used for generating the alternating voltage. Also, a charging device for the batteries is continued to be used, which increases the weight of the battery storage system.

Apart from electric power properties, size, weight etc., the electric safety of the energy supply system plays an essential role, e.g. in order to simplify the handling of the energy supply system during its installation and a transport and to ensure a reliable and safe operation.

DE 10 2019 110 177 A1 owned by the applicant describes a mobile energy supply system with an improved performance and lower weight. The energy supply system has a plurality of battery modules that can be connected in series in a time-variable manner by a central control unit, in order to provide an alternating voltage at an output of the supply system. Each battery module has an input connection and an output connection, a battery unit and a circuit, which selectively connects the battery unit to the input connection and the output connection. In this case, a fuse may be provided between the battery unit and the input/output connection, which causes the battery unit to be disconnected from the module connections in the case of a current flow that is too large. Moreover, a module-intern disconnection device may be provided, in order to cause a disconnection from one or several module-internal components if necessary.

### SUMMARY

Against this background, the disclosure provides an improved energy supply system and a method for operating an energy supply system, which are characterized by a high level of electrical safety, reliability, long endurance and lifespan as well as low production costs.

This is accomplished by providing an energy supply system having the features described herein and a method for operating an energy supply system having the features described herein. Other particularly advantageous embodiments of the disclosure are disclosed by the respective dependent claims.

It must be noted that the features cited individually in the claims can be combined with each other in any technologically meaningful manner (also across the boundaries of categories, such as method and device) and represent other embodiments of the disclosure. The description, in particular in connection with the Figures, additionally characterizes and specifies the disclosure.

It may also be noted that a conjunction “and/or” used hereinafter, which is situated between two features and links them to each other, should always be interpreted such that, in a first embodiment of the subject matter according to the disclosure, only the first feature may be provided, in a second embodiment, only the second feature may be provided, and in a third embodiment, both the first and the second feature may be provided.

A term “about” used herein specifies a tolerance range which the person skilled in the art working in the present field considers to be common. In particular, the term “about” is to be considered to mean a tolerance range of the quantity concerned of up to a maximum of +/−20%, preferably up to a maximum of +/−10%.

Within the sense of the disclosure, moreover, relative terms used herein concerning a feature, such as “larger”, “smaller”, “higher”, “lower”, “heavier”, “lighter” and the like are always to be interpreted such that deviations in size of the feature concerned, which are caused by production and/or realization and are within the production/realization tolerances defined for the production or realization of the respective feature, do not fall under the respective relative term. In other words, a size of a feature is to be considered as being, for instance, “larger”, “smaller”, “higher”, “lower”, “heavier”, “lighter” and the like within the sense of the disclosure, than a size of a compared feature if the two compared sizes only differ so clearly in their amount that this difference in size certainly does not fall under the tolerance range of the feature concerned caused by the production/realization, but rather is the result of targeted action.

According to the disclosure, an energy supply system has several battery modules, which can be controllably connected in series in order to provide different (i.e. time-variable) voltages at a power supply connection of the energy supply system. The energy supply system further has a control unit, which may be a central control unit of the energy supply system, for controlling the battery modules. Each battery module has an input connection and an output connection, a battery unit for providing a module voltage, and a switching device for selectively switching the module voltage to the input connection and to the output connection. The battery modules further each have a control input for receiving a control input signal. The several battery modules are each configured so as to assume, in response to a switch-off control signal at the control input, a switched-off state in which the module voltage is (electrically) disconnected from the input and output connections. Moreover, the several battery modules each have a detection circuit for detecting in each case an own impermissible operating state and a control output for outputting the detected impermissible operating state by means of a fault control signal. The energy supply system has a fault control circuit, which connects the control output of at least one of the several battery modules to the control input of at least one other of the several battery modules.

The disclosure is based on the insight that a locally detected critical fault in one of the battery modules cannot always be corrected by locally switching off the faulty battery module. If, for instance, the switching device has several switching elements, such as MOSFETs, for instance, for selectively switching the module voltage to the input connection and the output connection of the battery module (wherein the switching elements can be connected, for example, in the form of a bridge circuit), and if the switching elements (or the bridge circuit) of the faulty battery module are put into a high-ohm state after a locally determined fault while the rest of the system continues to run, the voltage still externally applied to the input connection and the output connection at the faulty battery module due to the series connection of the several battery modules may lead to a forced charging of the battery module via the MOSFET body diodes. Thus, the actual problem may even be aggravated by a large development of heat and, possibly, by an overloading of the battery module.

Moreover, the local occurrence of a critical (untreated) fault in the battery module concerned may offer a suggestion of a higher-level fault in the system control, so that a reliable communication between the control unit and the battery modules, e.g. in order to properly switch off the rest of the battery modules, cannot be relied upon.

This is where the disclosure comes in by enabling a decentralized detection and switching-off in the several battery modules. According to the disclosure, each battery module is made capable of reliably switching off at least one or even several of the other battery modules in the case of a detected own impermissible operation condition (i.e. a critical fault state).

Critical operating states that can be detected by the battery module by means of, for instance, suitable sensors and/or detecting circuits, may be, for instance (without any limitation thereto):
A high/low module voltage and/or cell voltage of individual battery cells of the battery unit
A high/low module and/or cell temperature during charging/discharging
Too large a difference of the cell voltages between individual battery cells (debalancing) of the battery unit
Other measurements suggesting a critical fault of battery cells of the battery module/battery unit
Other measurements suggesting a critical switching fault in the battery module

The fault detection and switch-off function on the module level, in addition to a central monitoring by the control unit of the energy supply system, which may possibly also be provided, provides a significant increase of the electrical safety of the system. In this way, a completely redundant, reliable fault switch-off of the entire energy supply system in the case of a critical operating state detected only in a single battery module can be realized in a simple manner. In the case where the control unit of the energy supply system cannot detect the critical module state or is not capable (anymore) to safely switch off the other battery modules, the complete electrical safety is nevertheless ensured in the energy supply system according to the disclosure.

It is to be understood that the fault control circuit may, in a simplest configuration, have only passive components, e.g. connecting lines. Moreover, it may also have active elements, e.g. a processor-controlled fault control unit.

An electrical voltage at the power supply connection, which varies over time, is to be understood to be a varying voltage at the power supply connection. Different voltages at the power supply connection may be generated by effectively connecting a changing number of battery modules (possibly also with a changing polarity) to the power supply connection at the same time, for instance, in order to generate an alternating voltage (e.g. 230 VAC).

The change between different battery modules while maintaining the same total number of battery modules active on the power supply connection, e.g. in order to provide a direct voltage, may also lead, in the sense according to the disclosure, to a change of the voltage at the power supply connection. Such a change may take place, for instance, in order to compensate changing module voltages dependent on the current charging state (SoC) of the respective battery modules. Of course, a direct voltage provided at the power supply connection may also take place by changing the battery modules simultaneously actively connected to the power supply connection in order to provide a connected consumer with, for instance, direct voltage levels varying over time.

The energy supply system may serve as an output connection to which electrical consumers can be connected and be provided for their operation with electrical energy from the battery modules. In addition, the power supply connection may also, if necessary, serve as an input connection with which a system-external electrical energy source, e.g. a conventional (low-voltage) power supply grid, can be connected in order to charge the battery modules, if the battery unit is a rechargeable battery unit. It is to be understood that, if necessary, a separate charging connection may also be provided in addition to the power supply connection on the energy supply system in order to cause a charging of the battery units by means of the system-external energy source.

The switching device may have several, preferably power-electronic, switching elements. The switching elements may be designed to selectively switch the module voltage to the input connection and the output connection for providing energy.

Power electronic switching elements are to be understood, in particular, such electronic components that are designed for converting electrical energy, e.g. for rectifying or inverting it, and/or for selectively supplying an electrical consumer with electrical energy, i.e. to electrically connect (switch) the consumer to an energy source (e.g. the battery unit of the battery module) or disconnect it therefrom (switch it off).

In order to selectively switch the module voltage of the battery unit to the input and output connection of the respective battery module, the switching elements may be connected in a bridge circuit, for instance, which is provided between the input connection and the output connection of the battery module and is designed to either connect the battery unit to the input and output connection or to connect the input connection to the output connection while bridging the battery unit. The connection of the battery unit to the input and output connection of the battery module may in this case take place only with a single predetermined polarity (e.g. a positive or negative polarity) or optionally with a first polarity (e.g. a positive polarity) and a second polarity inverted to the first one (e.g. a negative polarity). However, the disclosure is not limited to such a bridge circuit. Other circuit assemblies of the switching elements for selectively connecting the battery unit to the input and output connection of the battery module may also be provided.

According to an advantageous embodiment of the disclosure, the fault control circuit connects the control output of each of the several battery modules in each case to the control input of only a single other one of the battery modules. Thus, a so-called “daisy chain” of the battery modules can be realized in a simple manner, in which the several battery modules are connected to each other in series via the fault control circuit. The battery module detecting an own critical operating state can thus switch off its neighbor via the fault control signal, the latter its neighbor, etc., until all battery modules are switched off one after the other and the electrical safety of the energy supply system is ensured.

According to an alternative development of the subject matter of the disclosure, the fault control circuit can connect the control output of each of the several battery modules to the control input of every other one of the battery modules. This may be realized, for instance, by means of a star-shaped or bus-shaped connection of the battery modules to one another. The fault control signal of a single battery module may thus switch off all other battery modules in parallel, whereby the state of high electrical safety of the energy supply system in the event of a fault can be attained even more quickly.

According to an advantageous development, the fault control circuit may also have a separate fault control unit, which may be configured as a processor-controlled or transistor-controlled control unit, for instance. In any case, the fault control unit has a fault control input, to which the control output of at least one of the several battery modules is routed, and a fault control output, which is routed to the control input of at least one of the several battery modules. The fault control unit is configured to generate, in response to the presence of the fault control signal at the fault control input, the switch-off control signal at the fault control output. It is understood that the control outputs of all battery modules may be connected to the fault control input of the fault control unit and/or the fault control output of the fault control unit may be connected to the control inputs of all battery modules. The fault control unit functions as an independent, central unit that evaluates the signal applied to the fault control input and switches off the battery module or battery modules in the case of a fault.

Moreover, the fault control unit may be configured to deactivate further components of the energy supply system if a detected fault state is present. For example, the power supply connection may have a switching means with which the energy supply system can be disconnected from a connected consumer (i.e. during discharging) or a connected energy source (i.e. during charging) if required, particularly in the case of a fault, in order to even further increase the electrical safety of the energy supply system. In particular in the case of a charging process, the charging voltage applied to the power supply connection can be disconnected from all internal electric components of the energy supply system.

The fault control unit constitutes an active component of the fault control circuit, because it is configured for monitoring the fault control input for the presence of a fault control signal and to generate, in response to the detected fault control signal, the switch-off control signal at the fault control output. It may have, for instance, a microprocessor, microcontroller and the like or be formed by a transistor or logic gate circuit, without, however, being strictly limited thereto.

Another advantageous embodiment of the disclosure provides that the several battery modules each have a control connection, which forms both the control input and the control output, wherein the switch-off control signal and the fault control signal are routed via the control connection as a bi-directional control signal. In this way, the number of connections to be provided on the battery modules and the number of required signal lines can be considerably reduced (i.e. at least halved). In this manner, the energy supply system can be produced in a more cost-effective manner and has a simpler circuit design. Potential sources of faults in the energy supply system are thus also reduced, which further increases the reliability as well as the endurance and lifespan of the energy supply system.

Moreover, the several battery modules may advantageously each have at least one loop-through contact, which has an input contact and an output contact, which are connected to each other on the module-side in an electrically conducting manner. In this case, the fault control circuit can be configured to connect the control output and/or the control input of at least one of the battery modules in series with the loop-through contact of at least one other of the battery modules. In other words, a circuitry for transmitting the fault control signal and/or the switch-off control signal is realized, which includes the loop-through contact of at least one of the battery modules, preferably the loop-through contacts of all battery modules.

The input contact and output contact of the loop-through contact for connecting the control signal transmission line may in this case advantageously be arranged in a spatial vicinity, e.g. directly adjacent, to the connection to the control input and/or control output of the respective battery module. For instance, the connections for the input/output contact and for the control input and/or the control output may be realized by individual electrical connections (e.g. plug connections) that are independent of each other. Alternatively, they may also be incorporated individually, but together in a contacting housing (e.g. a plug housing). It was found that in a case of a fault, a plug connector accommodating all contacts as a rule detaches completely, but that at least contacts lying close to each other frequently detach together, whereby the passing-through of the corresponding control signal caused via the loop-through contact is also interrupted. Accordingly, a fault can be recognized by a detachment of a plug connection from one of the battery modules, and consequently, all other battery modules may be switched off in order to produce an electrically safe state of the energy supply system.

According to an advantageous further embodiment of the subject matter of the disclosure, the switch-off control signal causing the switched-off state of the several battery modules and/or the fault control signal representing the impermissible operating state of the several battery modules is an active low control signal. That means a digital low level signals the switching off (switch-off control signal) or the case of a fault (fault control signal). In all other cases, the corresponding control signal assumes a high level. For example, if an independent fault control unit is present, its failure may be recognized automatically by the absence of the active high signal, whereupon the battery modules deactivate themselves in the manner disclosed herein.

Preferably, the control output of the several battery modules can be configured, in an advantageous development of the subject matter of the disclosure, as a so-called open drain output (e.g. a field-effect transistor such as a MOSFET) or an open collector output (e.g. a bipolar transistor). Both terms are used synonymously without limitation to a respective transistor type. For instance, when active low control signals are used, the open drain output may be switched active against the ground potential (GND), whereas the high signal can be automatically generated in the case of an open drain/collector, e.g. by means of so-called pull-up resistors on the corresponding signal line.

Yet another advantageous embodiment of the disclosure provides that the fault control circuit has a data communication bus, which connects the several battery modules with each other, with at least one data transmission line, wherein the control output and/or the control input of the several battery modules is/are connected to the at least one data transmission line. For example, the data bus may be a CAN bus, which is well-known per se. The protocol of the data bus may in this case advantageously prohibit for a proper operation a (permanent or long-term) low signal, so that the case of a fault can be simply signaled via the data bus, which can be used per se in a conventional manner, by an active low signal in a unique manner for all bus subscribers (i.e. battery modules connected to the bus). In other words, the battery modules may draw the data bus line (longer than the bus protocol permits) to the ground potential (GND) in order to indicate a fault (control output). Because of a redundant circuit (e.g. a lowpass/timing element), it is also possible to recognize in the battery module that the data bus was impermissibly drawn onto GND and treat this as a switch-off signal (control input).

The case of fault or the switch-off signal may of course also be communicated via the data bus to all bus subscribers in a conventional manner, e.g. as a proper data packet in accordance with a communication protocol applicable for the respective data protocol. For instance, the fault control signal may be transmitted as a message packet via the data bus to a control unit (e.g. a fault control unit and/or a central control unit of the energy supply system), whereupon the latter switches off the battery modules in one of the manners disclosed herein.

The data bus may be a data bus used for the conventional communication between components of the energy supply system. The data bus may be the sole data bus of the energy supply system that provides two functions in this case, namely the conventional information exchange between different components of the energy supply system (e.g. the central control unit, battery modules, if necessary the fault control unit, etc.) and the fault and switch-off communication of the battery modules. The data bus for transmitting the fault state or of the switch-off control signal may also be a data bus redundant to another communication bus, which may be provided only for the special task of fault communication/fault switch-off.

Moreover, the several battery modules may each have an insulation device forming a galvanic isolation between the detection circuit and the fault control circuit, in order to further increase the electric safety between the battery modules and/or further components of the energy supply system (e.g. the central control unit). The galvanic isolation may take place, for instance, by means of an inductive coupling device or by means of an optocoupler.

Yet another advantageous embodiment of the disclosure provides a switching means connected to the fault control circuit, which is configured for separating the several battery modules from the power supply connection of the energy supply system upon the switch-off control signal being provided. In this way, a consumer connected to the energy supply system or a connected energy source for charging the battery modules can be safely disconnected from all electrical components of the system.

The impermissible operating state of the battery modules can be provided when a predetermined maximum or minimum voltage threshold value of the module voltage and/or cell voltages of several battery cells of the battery unit, a predetermined voltage difference between different battery cells of the battery unit, a predetermined maximum or minimum power threshold value at the power supply connection of the energy supply system and/or within the energy supply system (e.g. between battery modules), a predetermined maximum or minimum temperature threshold value of the several battery modules during a charging and/or discharging process and the like, are exceeded or fallen short of.

According to a preferred development of the subject matter of the disclosure, the energy supply system is configured as a mobile, in particular portable, energy supply system for the mobile power supply of an electrical consumer. As a portable supply system, the energy supply system preferably has a mass of less than 25 kilograms, in particular less than 20-15 kg. In this case, its size is limited such that it can be handled by a single person. For example, the energy supply system can advantageously be carried like a backpack, without, however, being strictly limited thereto.

Possible switching elements may preferably be MOSFET switches, particularly preferably N-channel MOSFET switches, with a breakdown voltage between about 30 V to about 100 V. This results in as small a number as possible of switching elements to be inserted, a smaller size of the energy supply system, smaller thermal losses of the switching elements, a higher efficiency in the voltage conversion or in the switching of the voltages. Thus, the electrical energy stored in the battery modules or battery units can be used even better, which results in a longer operation time/endurance. This is advantageous particularly in mobile applications, because the energy quantity carried along is limited and the energy density of the battery units directly influences the weight of the energy supply system.

Each battery unit may in each case have several battery cells. Lithium-ion cells, for instance, are preferably used battery cells, wherein the disclosure is not strictly limited to this cell type. Particularly advantageously, each battery unit has a maximum of so many battery cells that a total mass of the battery unit is 1 kg at most. Thus, the performance of the energy supply system can be maximized, wherein the mobility/portability of the system is maintained.

Moreover, the battery unit may have a maximum of 14 battery cells, wherein the number of the battery cells is preferably limited to a maximum of 6. This makes it possible to use switching elements (e.g. semiconductor switches, such as MOSFET) with a lower reverse voltage. The reverse voltage of the switching elements does not have to be designed for the reverse voltage of the generated system output voltage, but only for the maximum voltage of a battery module. For a battery module with, for instance, six lithium-ion cells in a series connection, the maximum module voltage is, for example, 6*4.2 V 32 25.2 V. Thus, a semiconductor switch with a reverse voltage of, for instance, 40 V can be used, for example. At the same size, such a component has static losses lower by a factor of 100, for instance, than a semiconductor switch with a reverse voltage of 650 V. Accordingly, the local heat development is lower by a factor of 100. This results, in a semiconductor switch with a volume resistivity of 1 mΩ in the closed state, in only about 0.25 watts heat development at a current of 16 A.

Moreover, the battery module may have a housing accommodating the battery unit and the switching device or the switching elements. In other words, the switching elements and the battery unit in this configuration form a constructional unit, which is accompanied by, in particular, advantages in relation to a compact size and a simplified management of thermal losses.

If a sufficiently large heat dissipation by means of a passive cooling is possible, the housing may also be hermetically sealed, because no openings are required, for example for an air exchange with the surroundings. This leads to a significantly reduced susceptibility with regard to dirt and moisture, so that the reliability is further increased and the possible range of application of the energy supply system is further increased. For example, an unlimited use in external regions and even under water (i.e. a watertight housing) is possible.

According to another aspect of the disclosure, a method for operating an energy supply system, e.g. an energy supply system according to one of the embodiments disclosed herein, has the steps:
providing several battery modules that can be controllably connected in series,
controlling the battery modules in order to provide different voltages at a power supply connection of the energy supply system, and
selectively switching a module voltage, which is provided in each case by one battery unit of the several battery modules, to an input connection and an output connection of the respective battery module by means of a switching device, in order to provide electrical energy at the input connection and the output connection,
receiving a control input signal via a control input of the respective battery module, wherein the several battery modules are brought, in each case in response to a switch-off control signal at the control input, into a switched-off state in which the module voltage is disconnected from the input and output connections,
wherein an impermissible operating state is detected in each case by the several battery modules by a respective detection circuit, and the detected impermissible operating state is outputted by means of a fault control signal at a control output of the respective battery module, wherein the fault control signal is transmitted from the control output of at least one of the several battery modules to the control input of at least one other of the several battery modules by means of a fault control circuit.

With regard to method-related definitions of terms and the effects and advantages of features of the method, reference may made in full to the disclosure of corresponding definitions, effects and advantages of the energy supply system according to the disclosure. Accordingly, disclosures regarding the energy supply system according to the disclosure may also be used, mutatis mutandis, for defining the method according to the disclosure, and vice versa, unless expressly excluded herein. A repetition of explanations of features that are basically the same, their effects and advantages may be omitted herein for the sake of a more compact description, without such omissions having to be interpreted as limitations.

### BRIEF DESCRIPTION OF THE DRAWINGS

Other advantages and features of the disclosure become apparent from the following description of exemplary embodiments of the disclosure, which shall be understood not to be limiting and which will be explained below with reference to the drawing. In this drawing, the Figures schematically show:

FIG. 1 shows a function diagram of an exemplary embodiment of an energy supply system according to the disclosure,

FIG. 2 shows a function diagram of a battery module of the energy supply system from FIG. 1,

FIG. 3 shows a detailed view of the energy supply system from FIG. 1,

FIG. 4 shows a function diagram of another exemplary embodiment of an energy supply system according to the disclosure,

FIG. 5 shows a function diagram of yet another exemplary embodiment of an energy supply system according to the disclosure, and

FIG. 6 shows a detailed view of a part of an exemplary fault control circuit of yet another exemplary embodiment of an energy supply system according to the disclosure.

### DETAILED DESCRIPTION OF THE DRAWINGS

In the various figures, parts that are equivalent with respect to their function are always provided with the same reference numerals, so that they are also only described once, as a rule.

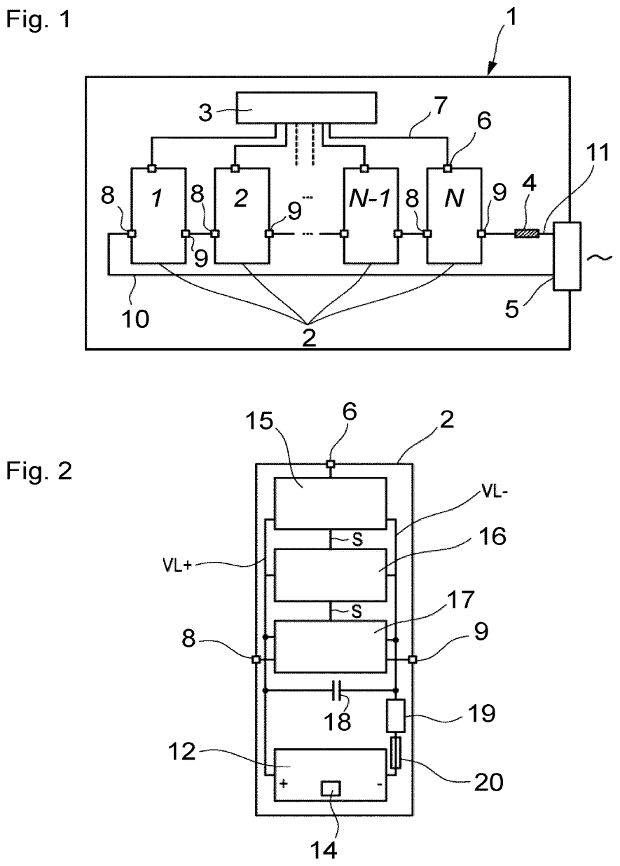

FIG. 1 shows a function diagram of an exemplary embodiment of an energy supply system 1 according to the disclosure. In the present case, this energy supply system 1 is configured as a mobile unit, in particular as a portable energy supply system, i.e. with a weight and size that can be handled by a single person. The weight of the energy supply system is below 25 kilograms, and the size is dimensioned such that the energy supply system can be carried as a backpack, for instance. It is to be understood that the disclosure, however, is not strictly limited to a mobile or portable configuration.

In FIG. 1, the energy supply system 1 has a number N of battery modules 2 (in the following also referred to as battery modules 2.1, 2.2, . . . , 2.N), which can be controllably connected in series. The control of the individual battery modules 2 can take place by means of a control unit 3, which in the present case, but without limitation, may be a central control unit of the energy supply system 1. The total voltage given off by the series-connected battery modules 2 can be smoothed by means of a smoothing reactor 4, for instance, and is applied to a power supply connection 5, which may be configured as a plug-in device, for instance. The plug-in device may be a standardized plug connection for 230 V alternating voltage devices, for instance, without, however, being strictly limited thereto.

As is further apparent from FIG. 1, each of the N battery modules 2 in the present case has a control connection 6, via which the control device 3 can transmit a control signal via a control line 7. Moreover, each battery module 2 has a module input 8 and a module output 9. It is remarked that “input” and “output” are arbitrarily designated. Particularly in the case of a controllable polarity of the battery modules 2, “input” and “output” cannot be functionally distinguished from one another. Thus, two inputs 8 or outputs 9 in the serial connection can be connected to one another by means of suitable control.

The N battery modules are in the present case arranged such that the module output 9 of one battery module 2 is electrically connected to the module input 8 of the following battery module 2. The module input 8 of the first battery module 2.1 is electrically connected via a line portion 10 to the power supply connection 5, and the module output 9 of the last battery module 2.N is electrically connected to the power supply connection 5 via the smoothing reactor 4 and another line portion 11, so that the outputted output voltage of the energy supply system 1 is present between the module input 8 of the first battery module 2.1 and the module output 9 of the last battery module 2.N.

In order to provide different voltages at the power supply connection 5 of the energy supply system 1, e.g. generate a substantially sinus-shaped alternating voltage at the output 5, the battery modules 2 are periodically controlled by the control unit 3 such that, selectively, none, one or several battery modules 2 are operatively connected to the power supply connection 5 in order to provide electrical energy at the system output 5.

For this purpose, the battery modules 2 may be connected in a so-called bridge circuit, for instance, which is provided between the input connection and the output connection of the battery module and is designed to either connect the battery unit 12 to the input and output connection 8, 9 (battery mode) or to connect the input connection 8 to the output connection 9 while bridging the respective battery unit 12 (bridging mode). However, the disclosure is not strictly limited to an arrangement of switching elements in the above-described bridge circuit. Other circuit assemblies can be used, which can selectively switch the module voltage to the input connection and the output connection 8, 9.

In any case, the individual battery modules 2, controlled by the control unit 3, can periodically change in the present case from a battery mode into a bridging mode and vice versa. In the battery mode, the module voltage of a battery unit 12 (FIG. 2) of the battery module 2 is present between the module input 8 and the module output 9 of a battery module 2. In contrast, the module input 8 and the module output 9 are electrically connected to one another in the bridging mode, so that there is no module voltage present between these points.

Consequently, by successively switching the battery modules 2 from the bridging mode into the battery mode, the output voltage at the power supply connection 5 can be increased in a stepped manner by the module voltage of a battery module 2. Equally, the output voltage can be reduced again in a stepped manner by successively switching back into the bridging mode. The possible voltages at the output consequently are between 0 V and N times the module voltage of one battery module 2.

By smoothing, if required, this step-shaped voltage pattern, a substantially sinus-shaped voltage pattern can be provided at the power supply connection 5.

It may be remarked that several of the N battery modules 2 may also be simultaneously switched back and forth between the bridging mode and the battery mode. Moreover, it may be remarked that the generation of only a half-wave was described above. The other half-wave can be generated in the same way, wherein a polarity reversal of the battery modules 2 can take place, for instance, at their respective input and output connections 8, 9.

FIG. 2 shows in a function diagram the basic structure of a battery module 2 of the energy supply system 1 from FIG. 1. As can be seen, the battery module 2 has a battery unit 12, which in turn has one or several battery cells (not shown), preferably rechargeable battery cells, such as lithium-ion cells, for instance. Moreover, the battery unit 12 may have a battery cell monitoring unit 14. The battery cell monitoring unit 14 monitors the cell voltages of the individual battery cells and can thus be considered a possible detection circuit in the sense of the disclosure, which is capable of detecting an impermissible operating state of the corresponding battery module 2, e.g. an impermissibly high/low module voltage and/or cell voltage, an impermissibly high/low module and/or cell temperature during charging/discharging of the battery cells, an impermissibly large difference of the cell voltages between individual battery cells of the battery unit 12 (i.e. debalancing).

As is also apparent from FIG. 2, the battery module 2 has in the present case an insulation device 15, a control device 16, a control device 17 that can have several switching elements (not shown), and a capacitor 18, which are arranged parallel to one another and to the battery unit 12 and are electrically connected via two supply lines VL+, VL to the battery unit 12. The supply lines VL+, VL− conduct the module voltage of the battery module 2 provided by the battery unit 12 and here also denoted with the reference signs VL+, VL−. In one or both of the supply lines VL+, VL−, a disconnection device 19 and a fuse 20 are provided in the present case in a series-connected manner. It is to be understood that the battery module 2 does not strictly have to have all/the components shown in FIG. 2. The battery module 2 may also have alternative or additional components (not shown).

In the present case, the control device 16 may be considered a (another/further) detection device in the sense of the disclosure if, besides the control of the switching device 17, it is also configured for detecting an impermissible operating state of the respective battery module 2. For instance, the control device 16 may be configured for detecting an impermissibly high/low module voltage VL+, VL−, an impermissibly high/low module temperature during charging/discharging, critical switching faults in the battery module 2 and the like.

It is apparent from FIG. 2 that the insulation device 15 is situated with one input on the control connection 6 of the battery module 2 in order thus to be able to receive a control signal, e.g. from the central control unit 3. Such a control signal can be forwarded via a control line S from the insulation device to the control device 16. In turn, a control signal can be transmitted via a control line S to the switching device 17 by the control device 16.

It is also apparent from FIG. 2 that the module input 8 and the module output 9 are each electrically connected to the switching device 17.

If switching elements of the switching device 17 are connected to the above-mentioned bridge circuit, the bridge circuit establishes in the battery mode a connection of the voltage line VL+ to the module input 8 and a connection of the voltage line VL− to the module output 9. Thus, the module voltage VL+, VL− provided by the battery unit 12, e.g. 3.6 V in the case of a single lithium-ion cell, is applied to the module input 8 and the module output 9. In the bridging mode, the bridge circuit can in contrast establish an electrical connection between the module input 8 and the module output 9, so that the battery unit 12 is uncoupled and the battery module 2 itself does not provide any voltage between the module input 8 and the module output 9. The basic structure of such a bridge circuit is well-known per se and therefore does not have to be described in any more detail.

The insulation device 15 can provide a galvanic isolation between the battery module 2 and the control unit 3. The galvanic isolation may take place, for instance, by means of an inductive coupling device or, for instance, by means of an optocoupler (both are not shown).

The fuse 20 (e.g. a melting fuse) situated in the supply line VL− may be provided in order to obtain an automatic disconnection of the battery unit 12 in the case of a too-large current flow. Alternatively, the disconnection device 19 and/or the fuse 20 may also be provided in the supply line VL+.

The disconnection device 19 may be provided in order to perform, if needed, a disconnection of the battery unit 12 from one or several of the other elements, such as the insulation device 15, the control device 16, the switching device 17 and the capacitor 18. This disconnection may take place in a controlled manner, e.g. by means of a control signal from the system-central control unit 3. In the present case, the disconnection of all elements takes place. However, it is also conceivable to disconnect only the switching device 17 from the battery unit 12. The disconnection device 19 itself may have one or several switching elements (not shown), e.g. MOSFET transistor(s). The switching element(s) of the disconnection device 19 may substantially be the same components as the switching elements of the switching device 17, without, however, being strictly limited thereto.

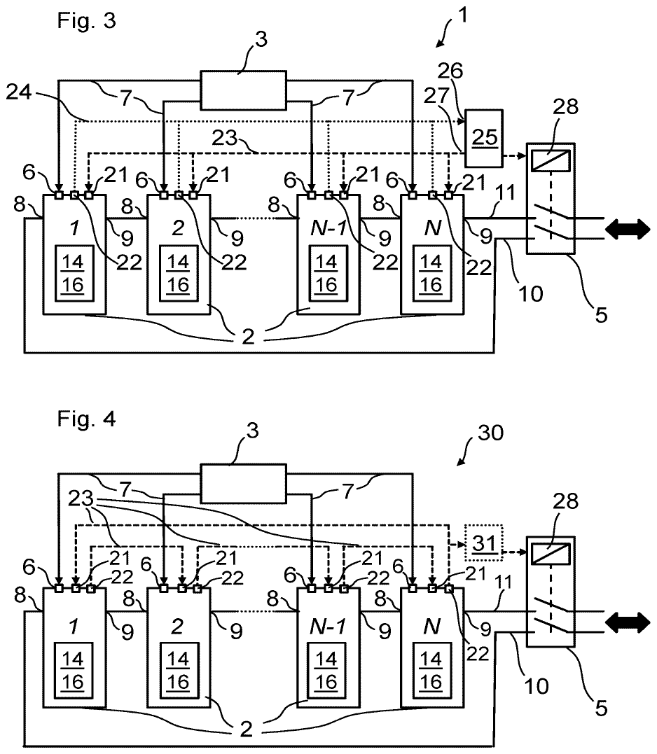

FIG. 3 shows a detailed view of the energy supply system 1 from FIG. 1. It is apparent from this view that the battery modules 2 of the energy supply system 1 have, in addition to the control connection 6, two further control connections, for instance, namely a control input 21 for receiving a control input signal, in particular a switch-off control signal, and a control output 22 for outputting a control signal, in particular a fault control signal. The several battery modules 2 of the energy supply system 1 are each configured so as to assume, in response to the switch-off control signal at the control input 21, which may be an active low control signal, for instance, a switched-off state in which the module voltage VL+, VL− is disconnected from the input and output connections 8, 9. Moreover, the battery modules 2 are configured in the present case to output, in each case at the control output 22, the impermissible operating state detected by the detection circuit 14 and/or 16 by means of the fault control signal, which may be an active low control signal, also by way of example.

It is also apparent from FIG. 3 that the energy supply system 1 has a fault control circuit, which in the exemplary embodiment shown in the present case has a signal line 23 for transmitting the switch-off control signal and a separate signal line 24 for transmitting the fault control signal. Moreover, the fault circuit of the exemplary embodiment shown has a separate fault control unit 25, which may be a processor-controlled control unit (e.g. a microprocessor, microcontroller and the like), for instance.

The fault control circuit of the energy supply system 1 connects the control output 22 of each of the several battery modules 2 by means of the fault control unit 25 to the control input 21 of each other one of the several battery modules 2. For this purpose, the fault control unit 25 has a fault control input 26, to which the control output 22 of the several battery modules 2 is routed, and a fault control output 27, which is routed to the control input 21 of the several battery modules 2. The fault control unit 25 is configured in the present case to generate, in response to the presence of the fault control signal at the fault control input 26, the switch-off control signal at the fault control output 27.

Moreover, the fault control unit 25 of the present energy supply system 1 is configured for controlling a switching means 28 (having a semiconductor switch, such as MOSFET, or a switching relay, for example), with which the several battery modules 2 can be disconnected from the power supply connection 5 of the energy supply system 1 upon the switch-off control signal being provided.

The signal lines 23, 24 can be data transmission lines of a single system-internal data communication bus (e.g. a CAN bus). The signal lines 23, 24 can also be data transmission lines of a second redundant data communication bus (e.g. a CAN bus). The signal lines 23, 24 may also be only simple control lines for transmitting the switch-off control signal or the fault control signal and be independent of a data communication bus that may possibly be provided.

The control output 22 of the several battery modules 2 may be configured as an open drain output or an open collector output.

Particularly preferably, the switch-off control signal and/or the fault control signal can be configured as an active low control signal.

FIG. 4 shows a function diagram of another exemplary embodiment of an energy supply system 30 according to the disclosure. The energy supply system 30 shown in FIG. 4 differs from the energy supply system 1 from FIG. 3 substantially only by the fault control circuit connecting the control output 22 of each of the several battery modules 2 in each case to the control input 21 of only a single other one of the battery modules 2, so that the battery modules 2 are connected to each other in series in accordance with the daisy chain principle. Once one of the battery modules 2 outputs the fault signal on one of the signal lines 23, the adjacent battery module 2 is switched off, which in turn switches its neighbor off etc. Thus, a fault control unit 25 as in the energy supply system 1 from FIG. 3 can be dispensed with. Nevertheless, the energy supply system 30 shown in FIG. 4 has at least one fault control unit 31, which in the present case provides at least one switching signal for switching the switching means 28 in the case of a fault. For this purpose, the fault control unit 31 may be configured as a simple transistor or logic gate circuit (not shown). A processor-controlled circuit is not strictly required.

Moreover, it is to be remarked that the fault control unit 31 (similar to the fault control unit 25 of the energy supply system 1) is not strictly required for the disclosure.

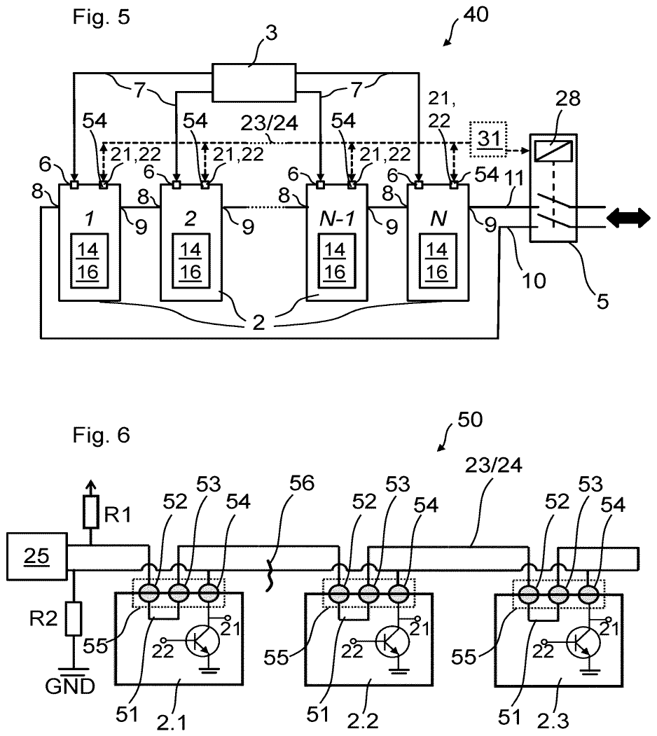

FIG. 5 shows a function diagram of yet another exemplary embodiment of an energy supply system 40 according to the disclosure. The energy supply system 40 shown in FIG. 5 differs from the energy supply system 30 from FIG. 4 substantially only by the several battery modules 2 each having a control connection contact, which forms both the control input 21 and the control output 22, wherein the switch-off control signal and the fault control signal are routed via the control connection contact as a bi-directional control signal. Furthermore, the control inputs and control outputs 21, 22 of all battery modules 2 are connected to one another in the energy supply system 40. The fault control unit 31 performs the same function as in the energy supply system 30 from FIG. 4, wherein the fault control unit 31 is basically not strictly required for the disclosure.

FIG. 6 shows a detailed view of a part of an exemplary fault control circuit of yet another exemplary embodiment of an energy supply system 50 according to the disclosure. By way of example, the energy supply system 50 has three battery modules 2, i.e. 2.1, 2.2 and 2.3.

Moreover, it can be seen that the several battery modules 2 each have at least one loop-through contact 51, which in turn has an input contact 52 and an output contact 53, which are connected to each other on the module-side in an electrically conducting manner. Moreover, each battery module 2 has a control connection contact 54, via which the control output 22 and, if necessary, the control input 21 of each battery module 2 can be routed.

In the present exemplary embodiment of the energy supply system 50, the control output 22 of the battery modules 2 is configured as an open drain output or an open collector output. Furthermore, the switch-off control signal and the fault control signal in the present case are each configured as an active low control signal. For this purpose, the signal line 23 may be connected via a first resistor R1 to a positive voltage potential (e.g. a supply voltage potential), and connected via a second resistor R2 to a ground potential (GND). Preferably, R2>>R1 applies for the second resistor. For example, R2 may have a 10-times greater resistance than R1.

In the present case, the connection contacts 52, 53, 54 are each accommodated in a common plug housing or plug connector 55 and form a common plug connector. However, this is not an absolute requirement. The connection contacts 52, 53, 54 can also each be connected, as individual, separated plug connectors, with the corresponding battery module 2.

Starting from the fault control unit 25, the signal line 23 or 24, in the fault control unit shown in FIG. 6, is first routed in series via the loop-through contacts 51 of each of the three battery modules 2 shown. The control connection contacts 54 of the battery modules 2 are connected only to the signal line 23 or 24 routed from the last battery module 2.3 of the series and back to the fault control unit 25, as can be seen in FIG. 6.

If, in a case of a fault, the plug connector 55 detaches from one of the battery modules 2, the passing-through of the corresponding control signal or the signal line 23/24 caused via the loop-through contact 51 is also interrupted. The resistor R2 causes the signal line 23/24 to be drawn to ground potential, which corresponds to the active low switch-off control signal, which consequently is applied to the control connection contact 54 of each battery module 2, and equally to the lower signal line connection of the fault control unit 25. Accordingly, a fault can be reliably recognized by a detachment of the plug connection 55 from one of the battery modules 2, and consequently, all other battery modules 2 may be switched off in order to produce an electrically safe state of the energy supply system 50.

The fault control circuit shown in FIG. 6 is also capable of recognizing a cable break 56 labeled, as an example, in FIG. 6. For this purpose, the fault control unit 25 recognizes at the lower signal line connection the active low switch-off signal caused after the cable break 56 by the resistor R2. Consequently, the fault control unit 25 can switch the signal line 23/24 connected to the upper signal line connection also active low, so that the battery modules 2 can safely switch off.

In one exemplary embodiment of the method according to the disclosure, several battery modules, e.g. modules 2, that can be controllably connected in series are provided for an operation of an energy supply system, such as the energy supply system 1 from FIG. 1, for instance. The battery modules are controlled (e.g. by means of the control unit 3) in order to provide different (i.e. time-variable) voltages at a power supply connection (e.g. connection 5) of the energy supply system.

Selectively, a module voltage (e.g. VL+, VL−), which is provided in each case by one battery unit (e.g. the battery unit 12) of each battery module, is switched to an input connection (e.g. the module input 8) and an output connection (e.g. the module output 9) of the battery module by means of a switching device 17, in order to provide electrical energy at the input connection and the output connection. Moreover, a control input signal is received via a control input (e.g. input 21) of the respective battery module, wherein the several battery modules are brought, in each case in response to a switch-off control signal at the control input, into a switched-off state in which the module voltage is disconnected from the input and output connections. An impermissible operating state in each case from the several battery modules is detected by means of a respective detection circuit (e.g. the cell monitoring unit 14 and/or the control device 16 of the switching device 17). The detected impermissible operating state is outputted by means of a fault control signal at a control output (e.g. the output 22) of the respective battery module, wherein the fault control signal is transmitted from the control output of at least one of the several battery modules to the control input of at least one other of the several battery modules by means of a fault control circuit (e.g. signal lines 23, 24 and, if necessary, the fault control circuit 25).

The energy supply system according to the disclosure disclosed herein and the method for operating an energy supply system according to the disclosure disclosed herein are not limited to the embodiments respectively described herein, but also include embodiments having the same effects, which result from technically viable other combinations of the features of the energy supply system and the method described herein. In particular, the features and combinations of features mentioned above in the general description and the description of the Figures and/or shown in the Figures alone can be used not only in the combinations explicitly specified herein, but also in other combinations or on their own, without departing from the scope of the present disclosure.

In a preferred configuration, the energy supply unit according to the disclosure is used as an energy supply system for the mobile power supply of high-performance working machines, in particular with an electric power consumption above 1 kW, such as diamond drills, high-pressure cleaners, industrial vacuum cleaners and the like, for instance. In this case, the energy supply system can preferably be a mobile, in particular portable, system.

What is claimed is:

1. An energy supply system, comprising:
a plurality of battery modules which can be controllably connected in series to provide different voltages at a power supply connection of the energy supply system, and
a control unit for controlling the battery modules,
wherein each battery module of the plurality of battery modules has an input connection and an output connection, a battery unit for providing a module voltage, a switching device for selectively switching the module voltage to the input connection and to the output connection, and a control input for receiving a control input signal, wherein each battery module of the plurality of battery modules is configured so as to assume, in response to a switch-off control signal at the control input, a switched-off state in which the module voltage is disconnected from the input and output connections,
wherein, in response to detecting an impermissible operating state of any battery module of the plurality of battery modules, a fault control circuit of the energy storage system is configured to transmit the switch-off control signal to cause each battery module of the plurality of battery modules to assume the switched-off state.

2. The energy supply system according to claim 1, wherein each battery module of the plurality of battery modules comprises a detection circuit for detecting, in each case, an impermissible operating state of the respective battery module and a control output for outputting the detected impermissible operating state by way of a fault control signal.

3. The energy supply system according to claim 1, wherein the energy supply system further comprises a fault control circuit which connects the control output of at least one battery module of the plurality of battery modules to the control input of at least one other battery module of the plurality of battery modules.

4. The energy supply system according to claim 1, wherein the fault control circuit connects the control output of each battery module of the plurality of battery modules in each case to the control input of only a single other battery module of the battery modules.

5. The energy supply system according to claim 1, wherein the fault control circuit is configured to connect the control output of each battery module of the plurality of battery modules to the control input of every other battery module of the plurality of battery modules.

6. The energy supply system according to claim 1, wherein the fault control circuit comprises a separate fault control unit having a fault control input to which the control output of at least one battery module of the plurality of battery modules is routed, and a fault control output which is routed to the control input of at least one battery module of the plurality of battery modules, wherein the fault control unit is configured to generate, in response to a presence of the fault control signal at the fault control input, the switch-off control signal at the fault control output.

7. The energy supply system according to claim 1, wherein each battery module of the plurality of battery modules has a control connection contact which forms both the control input and the control output, wherein the switch-off control signal and the fault control signal are routed via the control connection contact as a bi-directional control signal.

8. The energy supply system according to claim 1, wherein each battery module of the plurality of battery modules has at least one loop-through contact comprising an input contact and an output contact which are connected to each other on the module-side in an electrically conducting manner, and wherein the fault control circuit is configured to connect the control output and/or the control input of at least one battery module of the plurality of battery modules in series with the loop-through contact of at least one other battery module of the plurality of battery modules.

9. The energy supply system according to claim 1, wherein the switch-off control signal causes the switched-off state of each battery module of the plurality of battery modules.

10. The energy supply system according to claim 1, wherein the fault control signal representing the impermissible operating state of the plurality of battery modules is an active low control signal.

11. The energy supply system according to claim 1, wherein the control output of the plurality of battery modules is configured as an open drain output or an open collector output.

12. The energy supply system according to claim 1, wherein the fault control circuit comprises a data communication bus which connects the plurality of battery modules with each other with at least one data transmission line, wherein the control output and/or the control input of the plurality of battery modules is/are connected to the at least one data transmission line.

13. The energy supply system according to claim 1, wherein each battery module of the plurality of battery modules has an insulation device forming a galvanic isolation between the detection circuit and the fault control circuit.

14. The energy supply system according to claim 1, further comprising a switch connected to the fault control circuit, wherein the switch is configured to separate the plurality of battery modules from the power supply connection of the energy supply system upon the switch-off control signal being provided.

15. The energy supply system according to claim 1, wherein the impermissible operating state is provided when a predetermined maximum or minimum voltage threshold value of the module voltage and/or cell voltages of a plurality of battery cells of the battery unit, a predetermined voltage difference between different battery cells of the battery unit, a predetermined maximum or minimum power threshold value at the power supply connection of the energy supply system and/or within the energy supply system, a predetermined maximum or minimum temperature threshold value of the plurality of battery modules during a charging and/or discharging process, are exceeded or fallen short of.

16. The energy supply system according to any claim 1, wherein the energy supply system is mobile.

17. A method for operating an energy supply system, the method comprising:
providing a plurality of battery modules that can be controllably connected in series,
controlling the battery modules in order to provide different voltages at a power supply connection of the energy supply system,
selectively switching a module voltage, which is provided in each case by one battery unit of the plurality of battery modules, to an input connection and an output connection of the respective battery module by a switching device, in order to provide electrical energy at the input connection and the output connection,
detecting an impermissible operating state in at least one battery module of the plurality of battery modules, and
in response to detecting the impermissible operating state in at least one battery module of the plurality of battery modules, transmitting a switch-off control signal to cause each battery module of the plurality of battery modules to assume a switched-off state in which the module voltage is disconnected from the input and output connections.

18. The method for operating an energy supply system according to claim 17, wherein each battery module of the plurality of battery modules comprises a detection circuit for detecting the impermissible operating state and a control output for outputting the detected impermissible operating state by way of a fault control signal.

19. The method for operating an energy supply system according to claim 17, wherein a fault control circuit connects the control output of at least one battery module of the plurality of battery modules to the control input of at least one other battery module of the plurality of battery modules.

20. The method for operating an energy supply system according to claim 17, wherein each battery module of the plurality of battery modules has at least one loop-through contact comprising an input contact and an output contact which are connected to each other on the module-side in an electrically conducting manner, and wherein the fault control circuit connects the control output and/or the control input of at least one battery module of the plurality of battery modules in series with the loop-through contact of at least one other battery module of the plurality of battery modules.
